(19) United States
(12) Patent Application Publication
(10) Pub. No.: US 2013/0311801 A1
(43) Pub. Date: Nov. 21, 2013

(54) METHOD AND APPARATUS FOR CONTROLLING POWER CONSUMPTION

(71) Applicant: SAMSUNG ELECTRONICS CO., LTD., Suwon-si (KR)

(72) Inventors: Jae Sop KONG, Hwaseong-si (KR); Keung Kyu KWON, Hwaseong-si (KR); Taek Kyun SHIN, Hwaseong-si (KR)

(73) Assignee: SAMSUNG ELECTRONICS CO., LTD., Suwon-si (KR)

(21) Appl. No.: 13/830,373

(22) Filed: Mar. 14, 2013

(30) Foreign Application Priority Data
May 15, 2012 (KR) 10-2012-0051498

(51) Int. Cl. G06F 1/26; G06F 1/32

(52) U.S. Cl. CPC G06F 1/26; G06F 1/3206
USPC 713/320; 713/300

(57) ABSTRACT

A method of controlling power consumption of a portable device includes monitoring whether the portable device has connected to a docking station; and selecting and executing one of a plurality of power consumption controlling algorithms according to a monitoring result.

### CROSS-REFERENCE TO RELATED APPLICATIONS

This application claims priority under 35 U.S.C. §119(a) from Korean Patent Application No. 10-2012-0051498 filed on May 15, 2012 in the Korean Intellectual Property Office, the contents of which are herein incorporated by reference in their entirety.

### BACKGROUND

Exemplary embodiments are directed to a technique for controlling power consumption, and more particularly, to a method and apparatus capable of utilizing different power consumption controlling algorithms according to whether a portable device and a docking station are connected to each other.

Portable devices such as smart phones and tablet personal computers (PCs) operate using a voltage provided from a chargeable battery. The usage time of the portable devices may be increased by improving battery performance or by controlling the power consumption of the portable device.

Dynamic voltage scaling (DVS) is a common technique for controlling power consumed by a computer by increasing or decreasing a voltage for use in a component of the computer, for example, a microprocessor, according to the surrounding environment. Dynamic frequency scaling (DFS) is a common technique for adjusting the frequency of a clock signal, which is provided to a component of a computer, in real time to reduce heat generated in the component or power consumption of the component.

Dynamic voltage and frequency scaling (DVFS) may be used together in portable devices to reduce power consumption thereof. Portable devices require less power consumption and heat control.

### SUMMARY

According to an aspect of the present disclosure, there is provided a method of controlling power consumption of a portable device, the method comprising monitoring whether the portable device has connected to a docking station; and selecting and executing one of a plurality of power consumption controlling algorithms according to a monitoring result. The monitoring is performed by having the portable device handshake with the docking station.

The plurality of different power consumption controlling algorithms may be different dynamic voltage and frequency scaling (DVFS) programs. Each power consumption controlling algorithm respectively controls a maximum temperature and a minimum temperature of the portable device. Different power consumption controlling algorithms are associated with different maximum temperatures and different minimum temperatures.

The method further comprises, when the portable device has connected to the docking station, analyzing characteristic information of a processing device included in the portable device, wherein the power consumption controlling algorithm to be executed is selected based on the monitoring result of and the characteristic information.

The characteristic information indicates a connection relationship between a processor chip and a memory chip that are included in the processing device. When the characteristic information indicates that the processor chip and the memory chip are vertically connected, a maximum junction temperature of the memory chip is controlled by the selected power consumption controlling algorithm.

When the characteristic information indicates that the processor chip and the memory chip are horizontally connected, a maximum junction temperature of the processor chip is controlled by the selected power consumption controlling algorithm.

A maximum temperature controlled by the selected power consumption controlling algorithm is a surface temperature of the portable device.

Each of the power consumption controlling algorithms controls at least one of a clock signal frequency and a voltage provided to at least one processor implemented in the portable device based on an internal temperature of the portable device. The method further comprises selecting the power consumption controlling algorithm according to an application to be executed in the portable device, wherein different applications are respectively associated with different maximum temperatures controlled by the power consumption controlling algorithms.

According to another aspect of the present disclosure, there is provided a system for controlling power consumption, the system comprising a communication port which monitors whether a connection exists with a docking station and outputs a monitoring signal corresponding to a monitoring result; and a processing device which selects and executes one of a plurality of power consumption controlling algorithms in response to the monitoring signal.

The system may further comprise a storage which stores characteristic information about the processing device. The processing device may select the power consumption controlling algorithm according to the monitoring signal and the characteristic information. The system may further comprise an adjustment circuit which adjusts at least one of a clock signal frequency and a voltage that are provided to the processing device, under the control of the selected power consumption controlling algorithm.

The system may further comprise a temperature management unit which periodically monitors an ambient temperature of the processing device and outputs temperature information corresponding to a monitoring result. The selected power consumption controlling algorithm outputs control signals to the adjustment circuit based on the temperature information.

Each power consumption controlling algorithm respectively controls a maximum temperature and a minimum temperature of the processing device, wherein different power consumption controlling algorithms are associated with different maximum temperatures and different minimum temperature. A clock signal frequency controlled by ae power consumption controlling algorithm selected when the system has connected to the docking station may be higher than a clock signal frequency controlled by a power consumption controlling algorithm selected when the system has not connected to the docking station. The system may be a portable device.

The docking station may include a second communication port that handshakes with the first communication port.

According to an embodiment, the first and second communication ports may communicate with each other via a universal serial bus (USB) or a high-definition multimedia interface (HDMI). According to another embodiment, the first and second communication ports may communicate with each other via a wireless communication protocol.

According to another aspect of the present disclosure, there is provided a computer program product including a computer readable storage medium having a computer readable program stored therein that when executed by a computing device performs method steps for controlling power consumption of a portable device. The method steps include selecting one of a plurality of power consumption controlling algorithms according to whether the portable device has connected to a docking station; and executing said selected power consumption controlling algorithm, wherein said power consumption controlling algorithm controls at least one of a clock signal frequency and a voltage which are provided to at least one processor installed in the portable device based on an internal temperature of the portable device.

Each power consumption controlling algorithm respectively controls a maximum temperature and a minimum temperature of the portable device. Different power consumption controlling algorithms are associated with different maximum temperatures and different minimum temperatures. The method may further include analyzing characteristic information of a processing device stored in the portable device. The characteristic information indicates a connection relationship between a processor chip and a memory chip that are included in the processing device and the power consumption controlling algorithm is selected based on the monitoring result and the characteristic information.

### BRIEF DESCRIPTION OF THE DRAWINGS

FIG. 1 is a schematic block diagram of a system including a portable device and a docking station, according to an embodiment of the present disclosure.

FIG. 2 is a table showing a variety of dynamic voltage and frequency scalings (DVFS) having different maximum temperatures and different minimum temperatures.

FIG. 3 is a table showing a relationship between a surface temperature and an internal temperature according to operation modes.

FIG. 4 is a flowchart of a method of controlling power consumption of a portable device, according to an embodiment of the present disclosure.

FIG. 5 is a block diagram of an embodiment of a processing device illustrated in FIG. 1.

FIG. 6 is a block diagram of another embodiment of the processing device illustrated in FIG. 1.

FIG. 7 is a block diagram of still another embodiment of the processing device illustrated in FIG. 1.

### DETAILED DESCRIPTION OF EXEMPLARY EMBODIMENTS

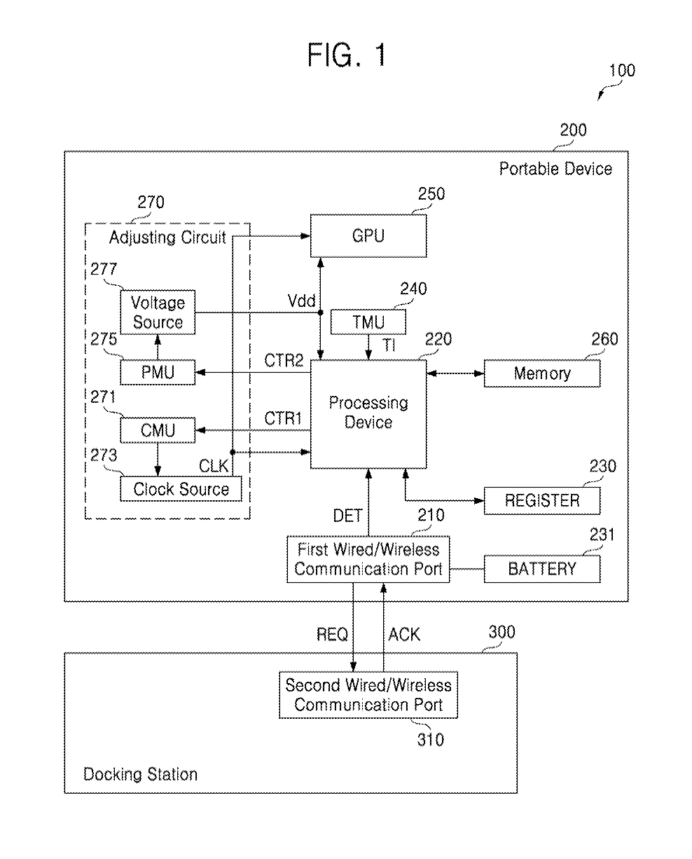

FIG. 1 is a schematic block diagram of a system 100 including a portable device 200 and a docking station 300, according to an embodiment of the present disclosure. Referring to FIG. 1, the system 100 includes the portable device 200 and the docking station 300. The portable device 200 is an example of a computing device.

The portable device 200 may be a mobile application set that a user can use on his or her palm, lap, etc. For example, the portable device 200 may be a laptop computer, a mobile phone, a smart phone, a tablet personal computer (PC), a personal digital assistant (PDA), an enterprise digital assistant (EDA), a digital still camera, a digital video camera, a portable multimedia player (PMP), a personal (or portable) navigation device (PND), a handheld game console, a game controller, or an c-book.

When the portable device 200 and the docking station 300 connect to each other in a wired or wireless manner, the docking station 300 provides a voltage (or power) to the portable device 200 in a wired or wireless manner. For example, a battery 231 of the portable device 200 may be charged by a voltage received from the docking station 300. Accordingly, the docking station 300 may serve as a battery charger for charging the battery 231 of the portable device 200 in a contacted or contactless charging manner.

The portable device 200 includes a first wired/wireless communication port 210, a processing device 220, a register 230, the battery 231, at least one temperature management unit (TMU) 240, a graphic processing unit (GPU) 250, a memory 260, and an adjustment circuit 270.

The first wired/wireless communication port 210 may communicate with a second wired/wireless communication port 310 of the docking station 300 and may determine whether the portable device 200 and the docking station 300 have connected to each other, based on a result of the communication.

Either independently or under the control of the processing device 220, the first wired/wireless communication port 210 may transmit a request signal REQ to the second wired/wireless communication port 310, and the second wired/wireless communication port 310 may transmit an acknowledge signal ACK to the first wired/wireless communication port 210 in response to the request signal REQ. In other words, the first wired/wireless communication port 210 may monitor whether the portable device 200 and the docking station 300 have connected to each other, by handshaking with the second wired/wireless communication port 310.

According to an embodiment, a communication channel between the first wired/wireless communication port 210 and the second wired/wireless communication port 310 may be implemented by using a wired communication channel, for example, a universal serial bus (USB) or a high-definition multimedia interface (HDMI). In other words, the first wired/wireless communication port 210 and the second wired/wireless communication port 310 may communicate with each other via a wired communication protocol, for example, a USB communication protocol or a HDMI communication protocol.

According to another embodiment, a communication channel between the first wired/wireless communication port 210 and the second wired/wireless communication port 310 may be implemented by using a wireless communication channel, for example, a wireless USB, a Certified Wireless USB (CWUSB), or an Ultra-WideBand (UWB). In other words, the first wired/wireless communication port 210 and the second wired/wireless communication port 310 may communicate with each other via a wireless communication protocol, for example, a wireless USB communication protocol, a CWUSB communication protocol, or an UWB communication protocol.

The second wired/wireless communication port 310 may also transmit energy to the first wired/wireless communication port 210 via a wireless power or energy transmission technology. Examples of a wireless power or energy transmission technology may include electromagnetic induction, non-radiative wireless energy transfer, etc. The first wired/wireless communication port 210 may include a rectenna, and the second wired/wireless communication port 310 may transmit microwaves.

According to a result of the monitoring, namely, according to a monitoring signal DET output by the first wired/wireless communication port 210, the processing device 220 may execute one of a plurality of power consumption controlling algorithms or programs. The processing device 220 may include a central processing unit (CPU) or a processor that is capable of controlling an entire operation of the portable device 200.

For example, according to embodiments, when the portable device 200 and the docking station 300 connect to each other, the first wired/wireless communication port 210 outputs the monitoring signal DET at either a first state, for example, a high level, or at a second state, for example, a low level.

Different power consumption controlling algorithms may be executed by the processing device 220 based on whether the monitoring signal DET is at the first state or the second state.

The power consumption controlling algorithms may be different dynamic voltage and frequency scaling (DVFS) programs, hereinafter referred to as “DVFS” programs. In other words, a DVFS uses temperature information TI received from the TMU 240 to control power consumption of the portable device 200 by controlling a frequency of a clock signal CLK and/or a voltage Vdd that are supplied to the processing device 220.

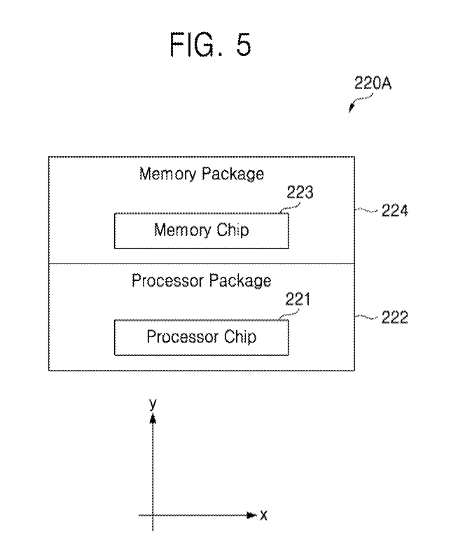

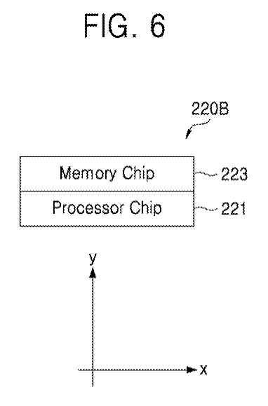

The register 230 can store characteristic information regarding a connection relationship or arrangement between at least one processor chip and at least one memory chip included in the processing device 220. For example, as shown in FIG. 5 or 6, the characteristic information may indicate that a processor chip 221 and a memory chip 223 are connected to each other in a vertical direction, for example, a Y-axis.

Examples of a vertical connection between the processor chip 221 and the memory chip 223 may include a package on package (PoP) implementation of the processing device 220 depicted in FIG. 5 and a system in package (SiP) implementation of the processing device 220 depicted in FIG. 6.

Referring to FIG. 5, a memory package 224 including the memory chip 223 may be stacked on a processor package 222 including the processor chip 221.

The memory chip 223 may include a volatile memory or a non-volatile memory.

The volatile memory may be implemented by, for example, a dynamic random access memory (DRAM), a static random access memory (SRAM), a thyristor RAM (T-RAM), a zero capacitor RAM (Z-RAM), a Twin Transistor RAM (TTRAM), etc.

The non-volatile memory may be implemented by, for example an electrically erasable programmable read-only Memory (EEPROM), a flash memory, a magnetic RAM (MRAM), a spin-transfer torque MRAM (STT-MRAM), a conductive bridging RAM (CBRAM), a ferro electric RAM (FeRAM), a phase change RAM (PRAM), a resistive RAM (RRAM), a nanotube RRAM, a polymer RAM (PoRAM), a nano floating gate memory (NFGM), a holographic memory, a molecular electronics memory device, an insulator resistance change memory, etc.

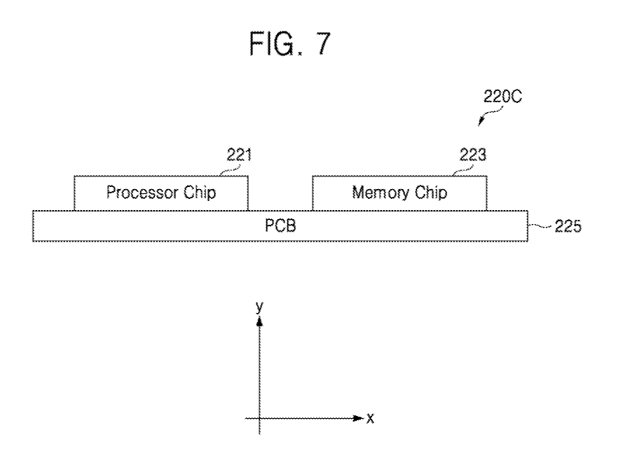

For example, as shown in FIG. 7, the characteristic information may indicate that at least one processor chip 221 and at least one memory chip 223 are mounted on a printed circuit board (PCB) 225 and are horizontally connected to each other, for example, along an X-axis.

According to other embodiments, the processing device 220 including a processor chip 221 and a memory chip 223 may be packaged into various packages.

At least one TMU 240 senses an ambient temperature of the processing device 220 and/or an ambient temperature of the GPU 250 and outputs temperature information TI to the processing device 220 according to a result of the sensing.

The processing device 220 outputs a first control signal CTR1 and a second control signal CTR2 to the adjustment circuit 270 according to the temperature information TI.

The GPU 250 may process graphics data that is used by the portable device 200.

The memory 260 may store data used by the portable device 200, the at least one application executable by the portable device 200, and/or other power consumption controlling programs. The memory 260 may include a volatile memory or a non-volatile memory.

The adjustment circuit 270 can control the frequency of the clock signal CLK and/or the voltage Vdd supplied to the processing device 220 or the GPU 250, based on the first and second control signals CTR1 and CTR2 received from the processing device 220.

The adjustment circuit 270 may include a clock management unit (CMU) 271, a clock source 273, a power management unit (PMU) 275, and a voltage source 277.

The CMU 271 may adjust the frequency of the clock signal CLK output by the clock source 273, in response to the first control signal CTR1 received from the processing device 220. For example, the clock source 273 may be implemented using a phase locked loop.

The PMU 275 may adjust the voltage Vdd output by the voltage source 277, in response to the second control signal CTR2 received from the processing device 220. For example, the voltage source 277 may be implemented using a voltage regulator. According to other embodiments, the voltage source 277 may be implemented using a specific integrated circuit capable of producing the voltage Vdd under the control of the PMU 275. According to other embodiments, at least one of the components 271, 273, 275, and 277 may be implemented as a part of the processing device 220.

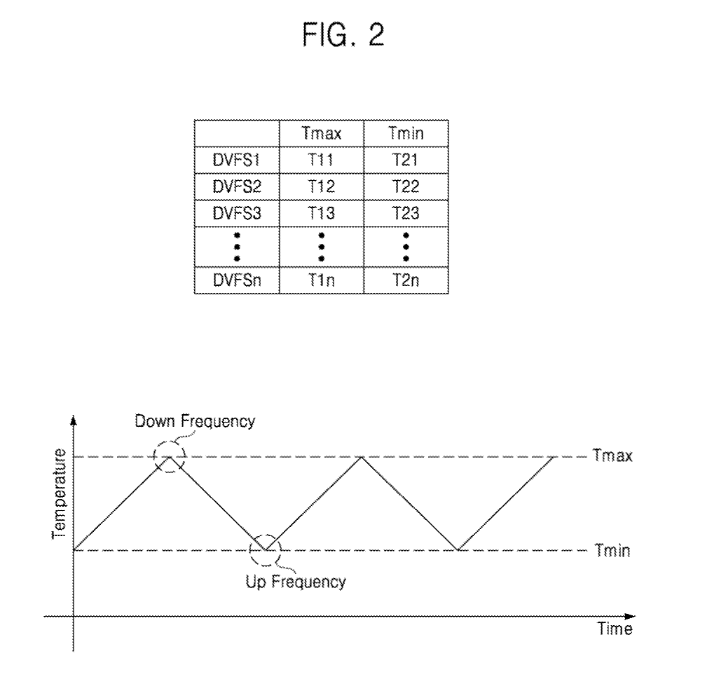

FIG. 2 is a table showing a variety of DVFS's having different minimum and maximum temperatures. Referring to FIGS. 1 and 2, in a first DVFS DVFS1, the frequency of the clock signal CLK and/or the voltage Vdd may be adjusted so that the processing device 220 or GPU 250 may operate between a first maximum temperature T11 and a first minimum temperature T21.

For example, in the first DVFS DVFS1, which is executable in the processing device 220, the first and second control signals CTR1 and CTR2 may be output to the adjustment circuit 270 according to the temperature information TI which is received periodically from the TMU 240 on-the-fly. For example, when the temperature information TI indicates a temperature that is higher than the first maximum temperature T11, the first DVFS DVFS1 executing on the processing device 220 outputs to the adjustment circuit 270 first and second control signals CTR1 and CTR2 for decreasing the clock signal CLK frequency or the voltage Vdd.

As the frequency of the clock signal CLK or the voltage Vdd provided to the processing device 220 or GPU 250 decreases, an internal temperature of the portable device 200 decreases.

Conversely, for example, when the temperature information TI indicates that the temperature is lower than the first minimum temperature T21, the first DVFS DVFS1 executing in the processing device 220 may output first and second control signals CTR1 and CTR2 to the adjustment circuit 270 for increasing the frequency of the clock signal CLK or the voltage Vdd.

As the frequency of the clock signal CLK or the voltage Vdd provided to the processing device 220 or GPU 250 increases, the internal temperature of the portable device 200 increases. In other words, since the first DVFS DVFS1 may adjust the frequency of the clock signal CLK or the voltage Vdd provided to the processing device 220 or the GPU 250 according to the temperature information TI, the first DVFS DVFS1 may control power consumption of the portable device 200.

In second through n-th DVFSs DVFS2 through DVFSn, the frequency of the clock signal CLK or the voltage Vdd may be adjusted so that the processing device 220 or GPU 250 may operate between second through nth maximum temperatures T12, T13, . . . , and T1n and second through n-th minimum temperatures T22, T23, . . . , and T2n, respectively. The first through n-th maximum temperature T11 through T1n may differ from one another, and the first through n-th minimum temperature T21 through T2n may differ from one another. As described above, different power consumption controlling algorithms may adjust the frequency of the clock signal CLK or the voltage Vdd so that the processing device 220 or GPU 250 may operate between different maximum temperatures and different minimum temperatures, respectively.

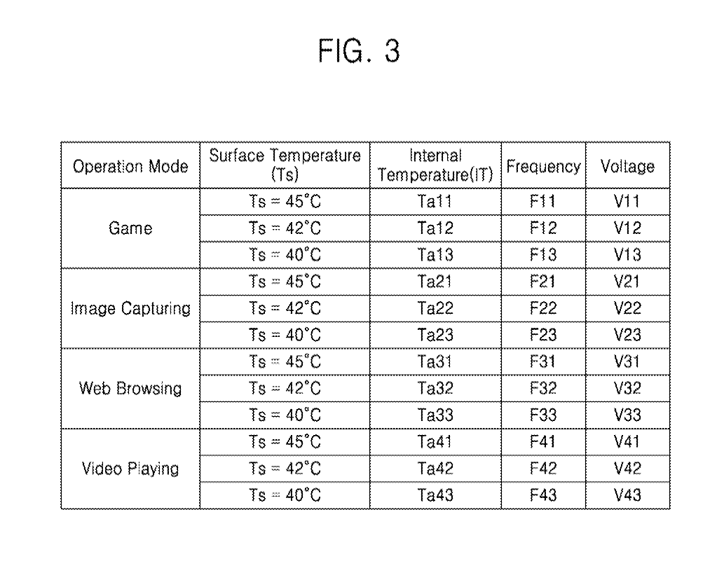

FIG. 3 is a table showing a relationship between a surface temperature Ts of the portable device 200 and an internal temperature IT of the portable device 200 as a function of operating modes. Referring to FIGS. 1 through 3, the portable device 200 may operate in a game mode executing a game application, an image capturing mode executing an image capturing application, a web browsing mode executing a web browsing application, a video playing mode executing a video playing application, etc. In other words, an operating mode may be determined by the application being executed by the processing device 220.

In each operating mode, the surface temperature Ts of the portable device 200 varies according to the internal temperature IT of the portable device 200. For example, in game mode, when the frequency of the clock signal CLK provided to the processing device 220 or the GPU 250 is F11 and the voltage Vdd is V11, the internal temperature IT of the portable device 200 is Ta11 and the surface temperature Ts of the portable device 200 is 45° C. In this case, the internal temperature IT may be determined according to the frequency F11 of the clock signal CLK and the voltage V11 provided to the processing device 220 or the GPU 250.

In game mode, when the frequency of the clock signal CLK provided to the processing device 220 or the GPU 250 is F12 (F12<F11) and the voltage Vdd is V12 (V12<V11), the internal temperature IT of the portable device 200 is Ta12 (Ta12<Ta11) and the surface temperature Ts of the portable device 200 is 42° C. In this case, the internal temperature IT may be determined according to the frequency F12 of the clock signal CLK and the voltage V12 provided to the processing device 220 or the GPU 250.

In game mode, when the frequency of the clock signal CLK provided to the processing device 220 or the GPU 250 is F13 (F13<F12) and the voltage Vdd is V13 (V13<V12), the internal temperature IT of the portable device 200 is Ta13 (Ta13<Ta12) and the surface temperature Ts of the portable device 200 is 40° C. In this case, the internal temperature IT may be determined according to the frequency F13 of the clock signal CLK and the voltage V13 provided to the processing device 220 or the GPU 250.

A relationship between a surface temperature, an internal temperature, a frequency, and a voltage in image capturing mode, web browsing mode, or video playing mode is similar to that in game mode.

Each internal temperature IT correlated with each surface temperature Ts may be set to a maximum temperature of each power consumption controlling algorithm, for example, DVFS. A minimum temperature corresponding to the maximum temperature may be appropriately set according to each power consumption controlling algorithm, for example, DVFS.

According to an embodiment, a computing device, for example, the portable device 200, may execute one of the power consumption controlling algorithms installed in the processing device 220, based on the monitoring signal DET and/or the characteristic information stored in the register 230.

According to another embodiment, a computing device such as the portable device 200 may execute one of the power consumption controlling algorithms loaded from the memory 260 into the processing device 220, based on the monitoring signal DET or the characteristic information stored in the register 230.

According to still another embodiment, a computing device such as the portable device 200 may load and execute one of the power consumption controlling algorithms from the memory 260 on-the-fly, based on the monitoring signal DET or the characteristic information stored in the register 230.

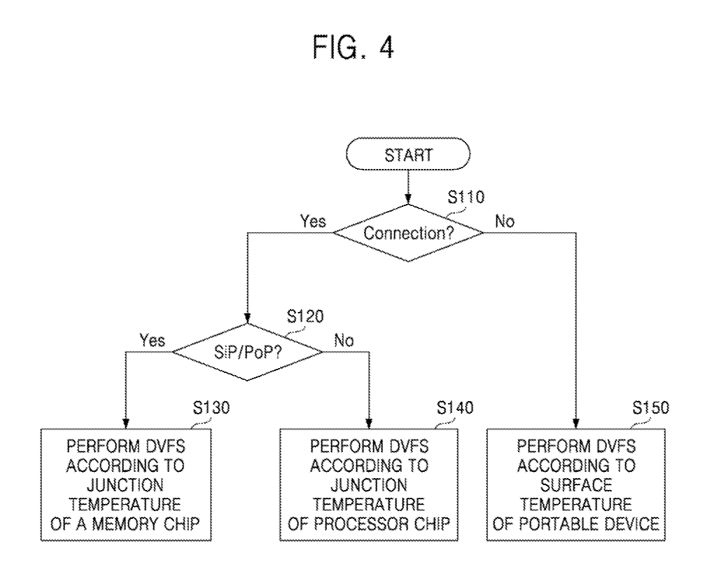

FIG. 4 is a flowchart of a method of controlling power consumption of the portable device 200, according to an embodiment of the present disclosure. Referring to FIGS. 1 through 4, the first wired/wireless communication port 210 monitors whether the portable device 200 and the docking station 300 have connected to each other, by a handshake with the second wired/wireless communication port 310, in operation S110.

When it is determined in operation 5110 that the portable device 200 has connected to the docking station 300, the monitoring signal DET may in a first state and in response the processing device 220 may execute a first power consumption controlling algorithm, for example, the first DVFS DVFS1.

Referring to FIG. 1, when the portable device 200 is booted, the power consumption controlling algorithms stored in the memory 260 may be loaded into the processing device 220, and the first power consumption controlling algorithm DVFS DVFS1, may be executed according to the monitoring signal DET. On the other hand, when it is determined in operation S110 that the portable device 200 has not connected to the docking station 300, the monitoring signal DET may be in a second state, and in response, the processing device 220 may execute a second power consumption controlling algorithm DVFS DVFS2.

In other words, the processing device 220 may select and execute one of the first DVFS DVFS1 and the second DVFS DVFS2, based on whether or not the monitoring signal DET indicates that the portable device 200 and the docking station 300 have connected to each other.

The first DVFS DVFS1, based on the temperature information TI periodically received from the TMU 240, may control the frequency of the clock signal CLK or the voltage Vdd so that the processing device 220 or the GPU 250 may operate between the first maximum temperature T11 and the first minimum temperature T21.

The second DVFS DVFS2, based on the temperature information TI periodically received from the TMU 240, may control the frequency of the clock signal CLK or the voltage Vdd so that the processing device 220 or the GPU 250 may operate between the second maximum temperature T12 and the second minimum temperature T22.

When the portable device 200 further includes the register 230, the processing device 220 may read and analyze the characteristic information stored in the register 230 in response to the monitoring signal DET being in the first state.

When, in operation S120, the monitoring signal DET is in the first state and the characteristic information indicates that the processing device 220 is implemented using an SiP or a PoP, the processing device 220 may execute a third power consumption controlling algorithm DVFS DVFS3, in operation S130.

The third DYES DVFS3 may control the frequency of the clock signal CLK or the voltage Vdd based on a temperature associated with a maximum junction temperature of the memory chip 223, for example, based on the third maximum temperature T13, in operation 5130. The maximum junction temperature may denote a maximum junction temperature of a device implemented on the memory chip 223 to ensure a normal operation of the memory chip 223, for example, a transistor. The temperature associated with the maximum junction temperature may be empirically measured or calculated.

The third DVFS DVFS3, based on the temperature information TI periodically received from the TMU 240, may control the frequency of the clock signal CLK or the voltage Vdd so that the processing device 220 or the GPU 250 may operate between the third maximum temperature T13 and the third minimum temperature T23.

On the other hand, in operation S120, if the monitoring signal DET is in the first state and the characteristic information indicates that the processing device 220 is implemented using a package other than an SiP and a PoP, the processing device 220 may execute an n-th power consumption controlling algorithm DVFS DVFSn, in operation S140.

The n-th DVFS DVFSn may control the frequency of the clock signal CLK or the voltage Vdd based on a temperature associated with a maximum junction temperature of the processor chip 221, for example, based on the n-th maximum temperature T1n, in operation 5140. The maximum junction temperature may denote a maximum junction temperature of a device implemented on the processor chip 221 to ensure a normal operation of the processor chip 221, for example, a transistor. The temperature associated with the maximum junction temperature may be empirically measured or calculated.

For example, the maximum junction temperature (for example, 125° C.) of the processor chip 221 may be higher than the maximum junction temperature (for example, 105° C.) of the memory chip 223.

In the n-th DVFS DVFSn, according to the temperature information TI periodically received from the TMU 240, the frequency of the clock signal CLK or the voltage Vdd may be controlled so that the processing device 220 or the GPU 250 may operate between the n-th maximum temperature T1n and the n-th minimum temperature T2n. For example, the third maximum temperature T13 may be lower than the n-th maximum temperature T1n.

Even when the portable device 200 and the docking station 300 have not connected to each other, the processing device 220 may selectively execute a power consumption controlling algorithm or program, such as DVFS, uniquely allocated for each operating mode or each executing application. The power consumption controlling algorithm uniquely allocated for each operating mode may be stored in the memory 260 or installed in the processing device 220.

Returning to operation S110, if it is determined that that the portable device 200 is not connected to the docking station 300, a method of controlling power consumption of the portable device 200 according to a present embodiment may dynamically control the internal temperature of the portable device 200, which is correlated with the surface temperature of the portable device 200, according to a dynamic thermal management (DTM) scheme at step S150.

In other words, a reference temperature based on a DTM scheme may be one of the surface temperature of the portable device 200 or the internal temperature of the portable device 200 correlated with the surface temperature.

In a DTM scheme according to an embodiment, the temperature information TI received from the TMU 240, which measures a temperature associated with the maximum junction temperature of the processor chip 221 or the memory chip 223, may be used to control the frequency of the clock signal CLK or the voltage Vdd provided to the processing device 220 to dynamically control the maximum junction temperature of the processor chip 221 or the memory chip 223.

A method of controlling power consumption of the portable device 200 described with reference to FIGS. 1 through 7 may be written as a computer-readable program or a computer-readable program code and stored in a computer readable storage medium. The computer-readable program or code may be executed by a computing device, such as a processor, an application processor (AP), or a CPU.

A method of controlling power consumption of a portable device according to an embodiment of the present disclosure may utilize different power consumption controlling algorithms based on whether the portable device and a docking station are connected to each other. Therefore, heat generated by the portable device may be adaptively controlled using different algorithms based on whether the portable device and the docking station have connected to each other, whereby performance of the portable device may be improved.

Moreover, the surface temperature of the portable device may be suitably adjusted, to prevent a user who uses the portable device for a long time from suffering low-temperature burns.

1. A method of controlling power consumption of a portable device, the method comprising:
monitoring whether the portable device has connected to a docking station; and
selecting and executing one of a plurality of power consumption controlling algorithms according to a monitoring result.

2. The method of claim 1, wherein the monitoring comprises the portable device handshaking with the docking station.

3. The method of claim 1, wherein the plurality of power consumption controlling algorithms are different dynamic voltage and frequency scaling (DVFS) algorithms.

4. The method of claim 1, wherein each power consumption controlling algorithm respectively controls a maximum temperature and a minimum temperature of the portable device, wherein different power consumption controlling algorithms are associated with different maximum temperatures and different minimum temperatures.

5. The method of claim 1, further comprising, when the portable device has connected to the docking station, analyzing characteristic information of a processing device included in the portable device, wherein the power consumption controlling algorithm to be executed is selected based on the monitoring result and the characteristic information.

6. The method of claim 5, wherein the characteristic information indicates a connection relationship between a processor chip and a memory chip that are included in the processing device.

7. The method of claim 6, wherein, when the characteristic information indicates that the processor chip and the memory chip are vertically connected, a maximum junction temperature of the memory chip is controlled by the selected power consumption controlling algorithm.

8. The method of claim 6, wherein, when the characteristic information indicates that the processor chip and the memory chip are horizontally connected, a maximum junction temperature of the processor chip is controlled by the selected power consumption controlling algorithm.

9. The method of claim 4, wherein the maximum temperature controlled by the selected power consumption controlling algorithm is a surface temperature of the portable device.

10. The method of claim 1, wherein each of the power consumption controlling algorithms controls at least one of a clock signal frequency and a voltage provided to at least one processor installed in the portable device based on an internal temperature of the portable device.

11. The method of claim 1, further comprising selecting the power consumption controlling algorithm according to an application to be executed in the portable device, wherein different applications are respectively associated with different maximum temperatures controlled by the power consumption controlling algorithms.

12. A system for controlling power consumption, the system comprising:
a first communication port which monitors whether a connection exits with a docking station and outputs a monitoring signal corresponding to a monitoring result; and
a processing device which selects and executes one of plurality of power consumption controlling algorithms in response to the monitoring signal.

13. The system of claim 12, further comprising a storage which stores characteristic information of the processing device,
wherein the processing device selects the power consumption controlling algorithm according to the monitoring signal and the characteristic information.

14. The system of claim 12, further comprising an adjustment circuit which adjusts at least one of a clock signal frequency and a voltage that are provided to the processing device, under the control of the selected power consumption controlling algorithm.

15. The system of claim 14, further comprising:
a temperature management unit which periodically monitors an ambient temperature of the processing device and outputs temperature information corresponding to a monitoring result,
wherein the selected power consumption controlling algorithm outputs control signals to the adjustment circuit based on the temperature information.

16. The system of claim 12, wherein each power consumption controlling algorithm respectively controls a maximum temperature and a minimum temperature of the processing device, wherein different power consumption controlling algorithms are associated with different maximum temperatures and different minimum temperatures.

17. The system of claim 12, wherein a clock signal frequency controlled by a power consumption controlling algorithm selected when the system has connected to the docking station is higher than a clock signal frequency controlled by a power consumption controlling algorithm selected when the system has not connected to the docking station.

18. (canceled)

19. The system of claim 12, wherein the docking station includes a second communication port that handshakes with the first communication port.

20. The system of claim 19, wherein the first and second communication ports communicate with each other via a universal serial bus (USB) or a high-definition multimedia interface (HDMI).

21. The system of claim 19, wherein the first and second communication ports communicate with each other via a wireless communication protocol.

22-24. (canceled)
